(19) United States
(12) Patent Application Publication
(10) Pub. No.: US 2021/0217091 A1
(43) Pub. Date: Jul. 15, 2021

(54) SYSTEMS AND METHODS FOR ENCRYPTED, DARK MESSAGING CONTINUITY AND BID NEGOTIATION OVER PEER TO PEER (P2P) COMMUNICATION

(71) Applicants: Dustin van Schouwen, Bronx, NY (US); Isaac Patka, Glenmont, NY (US)

(72) Inventors: Dustin van Schouwen, Bronx, NY (US); Isaac Patka, Glenmont, NY (US)

(21) Appl. No.: 16/946,403

(22) Filed: Jun. 19, 2020

Related U.S. Application Data
(60) Provisional application No. 62/864,715, filed on Jun. 21, 2019.

(51) Int. Cl. G06Q 40/06; H04L 29/06

(52) U.S. Cl. CPC G06Q 40/06; H04L 9/32; H04L 63/0428

(57) ABSTRACT

Systems and methods for encrypted, dark messaging continuity and bid negotiation over peer to peer communication are disclosed. Exemplary implementations include at least one processor; a network; a network communication device; and a data store positioned in communication with the at least one processor, network communication device, and the network. The data store containing instructions that, when executed by the at least one processor, cause the system to: generate, thru the at least one processor, a solicitation for the request; select, thru the network communication device, a vendor to provide the credentialed information; complete, thru the at least one processor, a validation process by the vendor with access to the credentialed information; and publish, onto the network, a record of the credentialed information by the vendor.

### CROSS-REFERENCE TO RELATED APPLICATIONS

The present application claims priority under 35 U.S.C. § 119(e) of U.S. Provisional Patent Application Ser. No. 62/864,715 filed on Jun. 21, 2019 and titled NOVEL PROTOCOL FOR ENCRYPTED, DARK MESSAGING CONTINUITY AND BID NEGOTIATION OVER PEER TO PEER (P2P) COMMUNICATION, the contents of which are incorporated herein by reference in their entirety.

### FIELD OF THE DISCLOSURE

The present disclosure relates to systems and methods for encrypted, dark messaging continuity and bid negotiation over peer to peer communication.

### BACKGROUND

Modern messaging and information validation systems require the ability to transfer and validate information between anonymous parties without having to exchanging personally identifying information as well as conduct transactions in the most economical way possible. Many public-ledger based frameworks currently require the need for costly work to be performed at all steps within the process of requesting, authorizing, validating, and producing information between peers on a network.

Centralized messaging systems rely on the authority of the company or entity running the system to uniquely identify individuals. These includes, but isn't limited to, multiparty systems like SMS, email, and single party systems like social media messengers, online auction houses, and/or gig economy platforms. Furthermore, centralized marketplaces connected to these messaging systems also rely on the authority of the company or entity running the medium to set prices for their services. Marketplaces in the same industry must dynamically adjust their prices to stay competitive.

This background information is provided to reveal information believed by the applicant to be of possible relevance to the present invention. No admission is necessarily intended, nor should be construed, that any of the preceding information constitutes prior art against the present invention.

### SUMMARY

One aspect of the present disclosure relates to a peer to peer-based messaging and verification system. The system may include at least one processor; a network; a network communication device; and a data store positioned in communication with the at least one processor, the network communication device, and the network. The data store may contain instructions that, when executed by the at least one processor, cause the system to: generate, thru the at least one processor, a solicitation for the request; select, thru the network communication device, a vendor to provide the credentialed information; complete, thru the at least one processor, a validation process by the vendor with access to the credentialed information; and publish, onto the network, a record of the credentialed information by the vendor.

In some implementations of the system, the processor may be further configured to secure a sum within an escrow account onto the network and release, onto the network, the sum from the escrow account in response to the publication of the record of the credentialed information.

In some implementations of the system, the processor may be further configured to transmit a plurality of requirements for the credentialed information onto the network.

In some implementations of the system, the processor may be further configured to add a plurality of negotiation elements to the solicitation, one of the negotiation elements including an element of work performed by the vendor and wherein the step of selecting the vendor is tied to the element of work.

In some implementations of the system, communications on the network may occur thru an encrypted direct channel.

In some implementations of the system, the processor may be further configured to confirm the identity of at least one peer thru the use of an encryption method.

Another aspect of the present disclosure relates to a method of transmitting and verifying peer to peer-based messages. The method may include generating a solicitation for a request of credentialed information; selecting a vendor to provide the credentialed information; completing a validation process by the vendor with access to the credentialed information; and publishing a record of the credentialed information by the vendor onto the network.

Yet another aspect of the present disclosure relates to a non-transient computer-readable storage medium having instructions embodied thereon, the instructions being executable by one or more processors to perform a method of transmitting and verifying peer to peer-based messages. The method may include generating a solicitation for a request of credentialed information; selecting a vendor to provide the credentialed information; completing a validation process by the vendor with access to the credentialed information; and publishing a record of the credentialed information by the vendor onto the network.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE DRAWINGS

The details of the present disclosure, both as to its structure and operation, can best be understood by referring to the accompanying drawings, in which like reference numbers and designations refer to like elements.

FIG. 1 illustrates an exemplary diagram of a peer to peer-based messaging and verification system 100, in accordance with one or more implementations.

FIG. 2 illustrates an exemplary diagram of a decentralized ledger network 104 found within the system 100, in accordance with one or more implementations.

FIG. 3 illustrates an exemplary data flow diagram of the protocol 300 tied to the peer to peer-based messaging and verification system 100, in accordance with one or more implementations.

FIGS. 4A, 4B, 4C, and/or 4D illustrates an exemplary method 400 of transmitting and verifying peer to peer-based messages, in accordance with one or more implementations.

### DETAILED DESCRIPTION

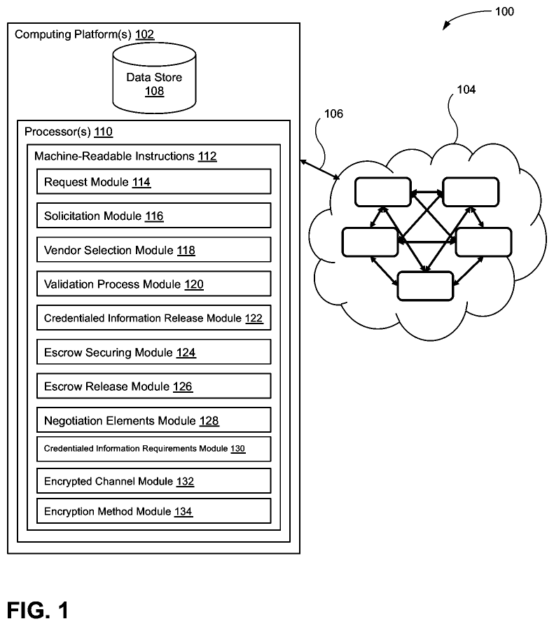

FIG. 1 illustrates a peer to peer-based messaging and verification system 100, in accordance with one or more implementations. In some implementations, the system 100 may including at least one computing platform(s) 102. Additional computing platform(s) 102 may be configured to communicate with the at least one computing platform(s) 102 according to a client/server architecture, a peer-to-peer architecture, and/or other architectures.

Computing platform(s) 102 may include or be positioned in communication with a data store 108, at least one processor(s) 110, a network communication device 106 and/or other components. Computing platform(s) 102 may include communication lines, or ports to enable the exchange of information with a network 104 and/or other computing platform(s) 102. Illustration of computing platform(s) 102 in FIG. 1 is not intended to be limiting. Computing platform(s) 102 may include a plurality of hardware, software, and/or firmware components operating together to provide the functionality attributed herein to computing platform(s) 102. For example, computing platform(s) 102 may be implemented by a cloud of computing platforms operating together as computing platform(s) 102 and may include one or more of a server, a desktop computer, a laptop computer, a handheld computer, a tablet computing platform, a smartphone, a gaming console, set-top device, internet-of-things (IoT) device, and/or other computing platforms.

Computing platform(s) 102 may be configured by machine-readable instructions 112. Machine-readable instructions 112 may include one or more instruction modules. The instruction modules may include computer program modules. The instruction modules may include one or more of a request module 114, a solicitation module 116, a vendor selection module 118, a validation process module 120, a credentialed information release module 122, an escrow securing module 124, an escrow release module 126, a negotiation elements module 128, a credentialed information requirements module 130, an encrypted channel model 132, an encryption method module 134, and/or other instruction modules.

Request module 114 may be configured to initiate a request for credentialed information by a requester 302 within the system 100.

Solicitation module 116 may be configured to generate, thru the at least one processor, a solicitation for the request. Other implementations of the system 100 may integrate the request module 116 and the solicitation module 116 such that the requester 302 generates both simultaneous.

Vendor selection module 118 may be configured to select, thru the network communication device, a vendor to provide the credentialed information.

Validation process module 120 may be configured to complete, thru the at least one processor, a validation process by the vendor with access to the credentialed information.

Credentialed information release module 122 may be configured to publish, onto the network, a record of the credentialed information by the vendor.

Escrow securing module 124 may be configured to secure a sum within an escrow account onto the network.

Escrow release module 126 may be configured to release, onto the network, the sum from the escrow account in response to the publication of the record of the credentialed information.

Negotiation elements module 128 may be configured to add a plurality of negotiation elements to the solicitation, one of the negotiation elements including an element of work performed by the vendor and wherein the step of selecting the vendor is tied to the element of work.

Credentialed information requirements module 130 may be configured to transmit a plurality of requirements for the credentialed information onto the network.

Encrypted channel model 132 may be configured to manage communications between modules within system 100 thru an encrypted direct channel.

Encryption method module 134 may be configured to confirm the identity of at least one peer thru the use of an encryption method.

The data store 108 may comprise non-transitory storage media that electronically stores information. The electronic storage media of data store 108 may include one or both of system storage that is provided integrally (i.e., substantially non-removable) with computing platform(s) 102 and/or removable storage that is removably connectable to computing platform(s) 102 via, for example, a port (e.g., a USB port, a firewire port) or a drive (e.g., a hard-disk drive). Data store 108 may include one or more of optically readable storage media (e.g., CD-ROM, DVD), magnetically readable storage media (e.g., magnetic tape, magnetic hard drive, floppy drive), electrical charge-based storage media (e.g., EEPROM, RAM), solid-state storage media (e.g., flash drive, solid-state hard drive), and/or other electronically readable storage media. Data store 108 may include one or more virtual storage resources (e.g., cloud storage, a virtual private network, and/or other virtual storage resources). Data store 108 may store software algorithms, information determined by processor(s) 110, information received from computing platform(s) 102, information received from the network 104, and/or other information that enables computing platform(s) 102 to function as described herein.

Processor(s) 110 may be configured to provide information processing capabilities in computing platform(s) 102. As such, processor(s) 110 may include one or more of a digital processor, an analog processor, a digital circuit designed to process information, an analog circuit designed to process information, a state machine, and/or other mechanisms for electronically processing information. Although processor(s) 110 is shown in FIG. 1 as a single entity, this is for illustrative purposes only. In some implementations, processor(s) 110 may include a plurality of processing units. These processing units may be physically located within the same device, or processor(s) 110 may represent processing functionality of a plurality of devices operating in coordination. Processor(s) 110 may be configured to execute modules 114, 116, 118, 120, 122, 124, 126, 128, 130, 132, 134, and/or other modules. Processor(s) 110 may be configured to execute modules 114, 116, 118, 120, 122, 124, 126, 128, 130, 132, and/or 134, and/or other modules by software; hardware; firmware; some combination of software, hardware, and/or firmware; and/or other mechanisms for configuring processing capabilities on processor(s) 110. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 114, 116, 118, 120, 122, 124, 126, 128, 130, 132, and/or 134 are illustrated in FIG. 1 as being implemented within a single processing unit, in implementations in which processor(s) 110 includes multiple processing units, one or more of modules 114, 116, 118, 120, 122, 124, 126, 128, 130, 132, and/or 134 may be implemented remotely from the other modules. The description of the functionality provided by the different modules 114, 116, 118, 120, 122, 124, 126, 128, 130, 132, and/or 134 described below is for illustrative purposes, and is not intended to be limiting, as any of modules 114, 116, 118, 120, 122, 124, 126, 128, 130, 132, and/or 134 may provide more or less functionality than is described. For example, one or more of modules 114, 116, 118, 120, 122, 124, 126, 128, 130, 132, and/or 134 may be eliminated, and some or all of its functionality may be provided by other modules of modules 114, 116, 118, 120, 122, 124, 126, 128, 130, 132, and/or 134. As another example, processor(s) 110 may be configured to execute one or more additional modules that may perform some or all of the functionality attributed below to one of modules 114, 116, 118, 120, 122, 124, 126, 128, 130, 132, and/or 134.

In some implementations, the computing platform(s) 102 may be operatively linked via one or more electronic communication links. For example, such electronic communication links may be established, at least in part, via a network 104, which is some cases may be a decentralized ledger network. The network 104 may include the Internet and/or other networks. It will be appreciated that this is not intended to be limiting, and that the scope of this disclosure includes implementations in which computing platform(s) 102 and the network 104 may be operatively linked via some other communication media or protocol.

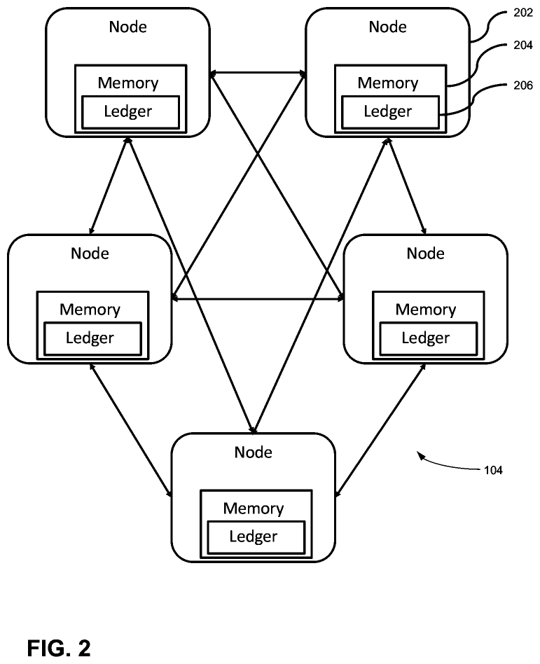

FIG. 2 illustrates an exemplary diagram of a network 104 as a decentralized ledger network found within the system 100, in accordance with one or more implementations. The network 104 may include a plurality of nodes 202, each node 202 in communication with at least one other node 202 within the network. Node(s) 202 may include computing platform(s) 102 but can also include any device capable of storing information and communicating over the network 104.

Each node 202 may further include a memory 204 that further stores all or a portion of a public ledger 206. The public ledger 206 may be utilized in order to store all or a portion of the instructions 112 tied to the system 100. By way of example, the public ledger may be used to store the blockchain smart contract 304 utilized within system 100, protocol 300, and method 400. The memory may consist of a data store 108 and may comprise non-transitory storage media that electronically stores information as discussed within this disclosure. By way of example, the network 104 may be a network tied to any public or private blockchain network or networks in connection with any of a plurality of cryptocurrencies described within this disclosure.

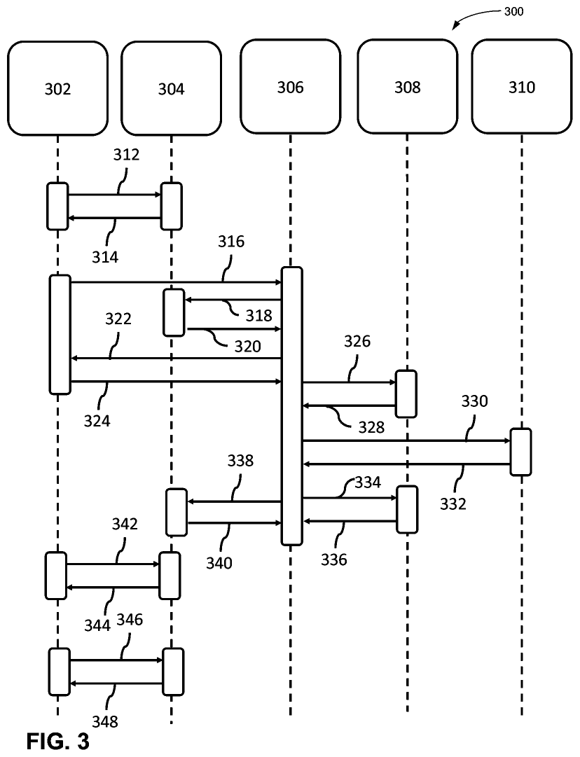

FIG. 3 illustrates an exemplary data flow diagram of the protocol 300 peer to peer-based messaging and verification system 100, in accordance with one or more implementations.

The protocol 300 may include any one of the peers that operate on the networks 104. These peers include requester(s) 302, verified data issuer(s) 306, consumer(s) 308, and/or issuer data provider(s) 310. Each of these peers communicates directly or indirectly with a blockchain smart contract 304 contained within the memory 204 of the network 104. The blockchain smart contract 304 may include any machine-readable instruction 112 that allows for the operation of functions on the network 104 and retained, either in whole or in part, within the ledger 206 of any memory 104. Any one of the peers may operate thru a computing platform(s) 102 or any other resource in communication with the network 104.

A requester 302 may be any party that initiates a request and/or solicitation for credentialed information as discussed within this disclosure. By way of example, a requester may be an end user wishing to anonymously verify credentialed information available to the other peers in communication thru the system 100. A verified data issuer 306 may be any party that is willing to answer the solicitation for credentialed information from the requester(s) 302. A consumer 308 may be any one or more parties that holds the credentialed information required by the requester 302. Furthermore, an issuer data provider 310 may be any one or more parties that can validate the credentialed information for the either the requester 302 or the verified data issuer 310. Alternate embodiments of the system 100 and protocol 300 may allow for the verified data issuer(s) 306, consumer(s) 308, and issuer data provider(s) 310 roles to be performed by the same parties or multiple combination(s) of parties as based on the nature of the credentialed information. Furthermore, in alternate embodiments of the system 100 and protocol 300 may allow for requester(s) 302 and consumer(s) 308 roles to be performed by the same parties or multiple combination(s) of parties. The term party or parties may constitute human-directed or automated computing platform(s) 102 or other system(s) depending on the implementation.

The following operations give an exemplary representation of the data flow of protocol 300 thru the messaging and verification system 100 as explained in this disclosure.

Initially, at operation 312, a requester 302 secures a sum within an escrow account within the escrow account portion of the smart contract 304. This may be a sum tied to the credentialed information or governed by the system 100 itself as indicated by the peers within the system 100. Any additional factors outside of the protocol 300 may also determine the initial sum within the escrow account. The sum may also be zero if the implementation of the system 100 allows for zero sum solicitations in order to initiate the protocol 300 and use the system 100.

At operation 314, the sum secured within the escrow account is confirmed by the smart contract 304 by way of a return receipt sent to the requester 302.

At operation 316, the requester 302 solicits for the verification of the credentialed data from the verified data issuer 306. By way of example, this solicitation may take the form of a solicitation message onto the network 104 containing all the necessary negotiation elements including, but not limited to, the type of credentialed information, identified encryption information of the requester 302, the allotted sum for the requested provision and/or validation of the credentialed information. Additional information may be included if required by the peer to complete the transaction. Verified data issuers 306 may listen for a compatible solicitation in order initiate any subsequent operations within the protocol 300.

At operation 318, the verified data issuer 306 may confirm the availability of the escrow funds within the smart contract 304 in order to bid on the solicitation for credentialed information from the requester 304. In other implementations of the system 100, this and the following operation 320 may be omitted. A situation for this implementation would be if the solicitation carries a zero sum amount, thus eliminating the need for securing a sum in escrow.

At operation 320, the smart contract 304 will respond with the read sum within escrow in order to allow the verified data issuer 306 to compare the read sum to the job value within the solicitation.

At operation 322, the verified data issuer 306 bids on the solicitation generated by the requester 302. By way of example, this bid may take the form of a response including the ability to validate and/or provide the credentialed information and any requested identifying encryption information tied the verified data issuer 306.

At operation 324, a requester 302 transmits a conditional payment authorization to the verified data issuer 306 in order to initiate the provision and validation of the credentialed information. This conditional authorization may be encoded thru the form of a partial encryption mechanism tied to the escrow account within the smart contract 304. The partial encryption mechanism may be exemplified by any of the encryption mechanism described within this disclosure.

At operation 326, the verified data issuer 306 requests the credentialed information from the consumer 308 and the information is subsequently shared at operation 328. In some implementations, these two operations may be merged if the verified data issuer 306 and the consumer 308 are the same party.

At operation 330, the credentialed information is validated by the issuer data provider 310. This will take the form of various validation mechanisms as exemplified within the validation step 406 of method 400 discussed below.

At operation 332, the verified data issuer 306 receives the validation response from the issuer data provider 310. In certain embodiments this may take the form of a confirmation of the credentialed information received by the issuer data provider 310 or may also include additional response information giving context behind the response, such as, a rejection due to: invalid information, incomplete information to complete the validation of credentialed information, and/or factors outside of the issuer data provider's 310 control. Additional validation responses and/or reasoned for the responses may be incorporated into operation 332 in accordance with the implementation of the system 100, protocol 300, and/or method 400.

At operation 334, the verified data issuer 306 may request a signature tied to the provided credentialed information in order to complete the transaction with the requester 302. The consumer 308 may subsequently provide the signature to the verified data requester 302 at operation 336. A signature may include any encrypted or obfuscated verification that confirms the completion of the work by the consumer 308. Furthermore, alternate implementations may merge these steps if these two roles are shared by the same entity.

At operation 338, the verified data issuer 306 submits verification of the credentialed information for payment by the smart contract 304. By example, this verification may take the form of a hash of the credentialed information recognized as valid by the smart contract 304 being released onto the network 104 in order to release the sum tied to the solicitation.

At operation 340, the verified data issuer 306 receives the sum from the escrow account within the smart contract 304, completing the transaction for the verified data issuer 306.

At operation 342, the requester 302 is listening for the release of the verification made by the verified data issuer 306 and subsequently receives the notification of a completed event at operation 344. The requester 302 may then utilize the verification on the network 104 in order to retrieve the credentialed information.

In alternate implementations, the protocol 300 may also have an operation 346 where the requester 302 checks the escrow account within the smart contract 304 in order to retrieve any remaining sum upon completion of the transaction. This may occur in situations where the same escrow account is tied to multiple solicitations for credentialed information and the bids provided by the verified data issuer 306 were lower than the sum secured within the escrow account. The requester 302 may also confirm that the escrow account is at a zero sum. Finally, the requester 302 may receive a receipt of the sum remaining within the escrow account at operation 348.

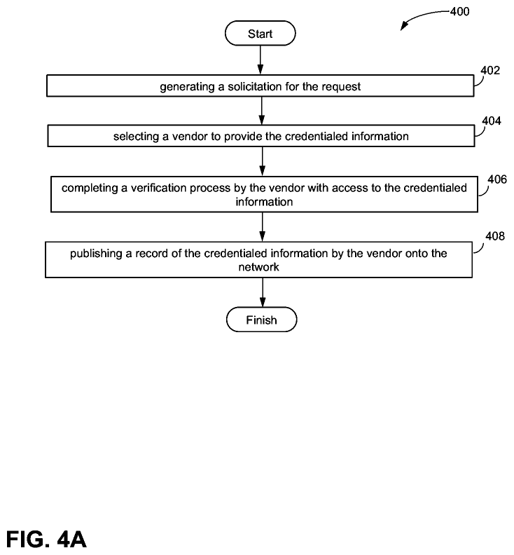

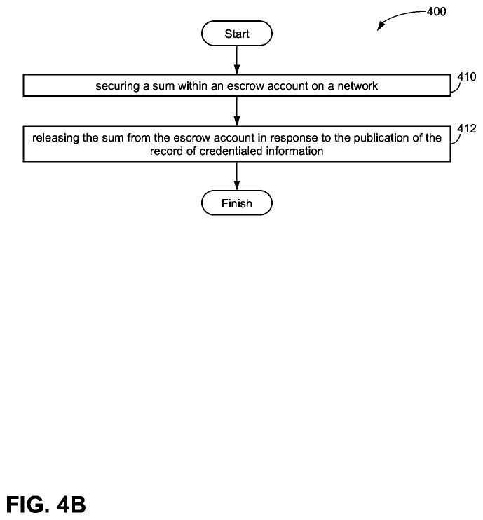

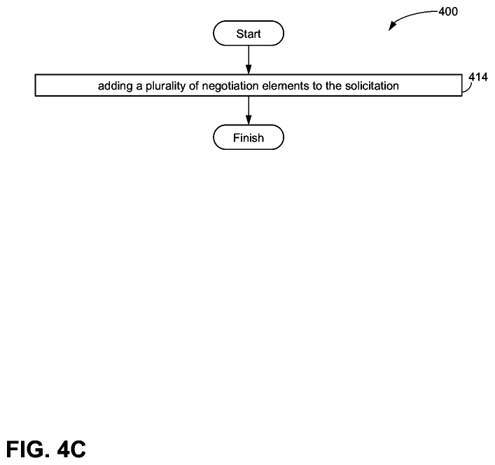

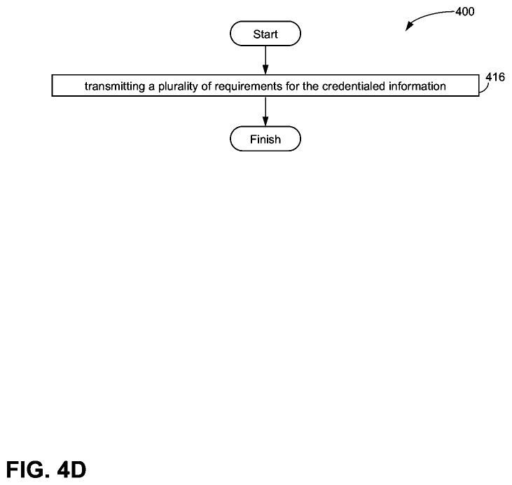

FIGS. 4A, 4B, 4C, and/or 4D illustrate a method 400 of transmitting and verifying peer to peer-based messages, in accordance with one or more implementations. The operations of method 400 presented below are intended to be illustrative. In some implementations, method 400 may be accomplished with one or more additional operations not described, and/or without one or more of the operations discussed. Additionally, the order in which the operations of method 400 are illustrated in FIGS. 4A, 4B, 4C, and/or 4D and described below is not intended to be limiting.

In some implementations, method 400 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 400 in response to instructions stored electronically on an electronic storage medium. The one or more processing devices may include one or more devices configured through hardware, firmware, and/or software to be specifically designed for execution of one or more of the operations of method 400.

FIG. 4A illustrates method 400, in accordance with one or more implementations.

At operation 402, method 400 may include generating a solicitation for a request of credentialed information. As previously discussed, this solicitation may take the form of a solicitation message onto the network 104 containing all the necessary negotiation elements including, but not limited to, the type of credentialed information, identified encryption information of the requester 302, the allotted sum for the requested provision and/or validation of the credentialed information.

At operation 404, method 400 may include selecting a vendor to provide the credentialed information. In some implementations, this selection may be tied to various requirements made by the requester 302 in order to accept the bid made by the other peers (for example a vendor or the additional parties within protocol 300).

Within method 400, the communications between the operations may occur thru an encrypted direct channel between peers on the network 104. This encrypted direct channel may use any of the encryption methods discussed within this disclosure and may encrypt all or some of the communications made between the peers on the network in order to maintain the security of the operations of method 400 on the network 104.

Furthermore, within method 400, the identity of at least one peer may be confirmed thru the use of an encryption method. This includes the identity of parties 304, 306, 308, and 310 as discussed in relation to FIG. 3. Encryptions methods may include either synchronous or asynchronous encryptions methods. By way of example, a public/private key pair may be used in order to verify the identity and maintain the identity of a verified data issuer 306 through the method 400 in order to secure the origin of the credentialed information. Additional encryption methods may be used in order to secure the communications and/or information within method 400 and is not limited to those described herein.

At operation 406, method 400 may include completing a validation process by the vendor with access to the credentialed information. This validation process may be standardized for all solicitations between peers in the system 100 or can be varied as addressed in additional operations below.

At operation 408, method 400 may include publishing a record of the credentialed information by the vendor onto the network 104. By way of example, a record of the credential information may be a cryptographic hash that allows the requester 304 to retrieve the credentialed information. Various forms of cryptographic hashes or other secured record identifiers may be used in order to identify the credentialed information to the requester 304 within the network 104.

FIG. 4B illustrates operations 410 and 412, in accordance with one or more implementations. At operation 410, method 400 may include securing a sum within an escrow account on the network 104. Furthermore, at operation 412, the method 400 may include releasing the sum from the escrow account in response to the publication of the record of the credentialed information as indicated in operation 408. By way of example, the sum may be any known form of cryptocurrency that is used in conjunction with the network 104. This may include Ethereum, Ethereum Classic, Bitcoin, Litecoin, or any such currency based on a proof of work or proof of stake blockchain. Additionally, non-cryptocurrency sums may be used for verification of the sum by an outside mechanism in communication with the system 100 prior to securing the sum at operation 410.

FIG. 4C illustrates operation 414, wherein method 400 may include adding a plurality of negotiation elements to the solicitation. Additionally, one of the negotiation elements may include an element of work performed by the vendor and the operation 404 of selecting the vendor is tied to the element of work. By way of example, the solicitation request may include a verification to be completed by the vendor parties (including the verified data issuer 306, consumer 308, or issuer data provider 310) that will need to be performed in order to perform an identity related verification. Additional scenarios are also provided by way of example: 1. Challenge Response via SMS, Email or similar medium: Once the requester 302 identifies a vendor to perform the work, they share the requester's 302 contact information in the encrypted direct messaging channel. The vendor sends a challenge code to the requester 302. The requester 302 returns the challenge code, and the vendor publishes the result of the verification for the requester 302 to access. 2. Watch list scanning: When a requester 302 wishes to scan a user against a watch list to comply with regulations, they have a variety of vendors to choose from. The requester 302 can generate a solicitation for a specific kind of watch list scan. The requesters 302 select a vendor using the network 104, then share the information to be scanned. The vendor performs the query and publishes the results for the requester 302 to access. 3. ID Document Verification: When a requester 302 wishes to verify a government issued document for their users, they can use the marketplace to find a vendor who will check the document via OCR, face matching, and/or other fraud detection methods. The vendor receives the documents via the encrypted channel, or via an out of band communication channel if the data is too large for placement on network 104. The vendor completes the job and publishes the result for the requester 302 to access. 4. Unrelated to identity verification: For example, within a ridesharing application, a requester 302 can put out a solicitation for bid via the network 104. Vendors (in this case drivers) are subscribed to specific types of solicitations (i.e. ride requests). Drivers respond with their bid, including a price, time to pick up, and their rating. Requesters 302 select a driver based on these criteria, and an encrypted channel is established between the parties. Now the user can share their exact location and contact information with the driver and the work can proceed. As shown by example here the system 100 may be used to enable a more efficient competitive marketplace for services across companies in the same industry, by having a dynamically adjusting market clearing price based on demand, without needing to trust a central authority.

FIG. 4D illustrates method 400, wherein method 400 may include selecting the vendor and further consists of transmitting a plurality of requirements for the credentialed information. These requirements may include validation type for the vendor to fulfill the request, the requirements for the record to be left on the network 104 by the vendor, or any additional information related to the solicitation.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium or data store may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a read only memory (ROM), optically readable storage media (e.g., CD-ROM, DVD), magnetically readable storage media (e.g., magnetic tape, magnetic hard drive, floppy drive), electrical charge-based storage media or random access memory (e.g., EEPROM, RAM), solid-state storage media (e.g., flash drive, solid-state hard drive), other electronically readable storage media and/or any suitable combination of the foregoing. In the context of this disclosure, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, and/or any suitable combination of the foregoing.

Computer program code for carrying out operations for aspects of the present invention may be written in any combination of one or more programming languages, including: object oriented programming languages such as Java, Smalltalk, C++, conventional procedural programming languages such as the “C” programming language or similar programming languages, scripting language such as Perl and/or VBS, functional languages such as Lisp and/or ML, logic-oriented languages such as Prolog, and/or blockchain smart contract languages such as Solidity, Move, Tezos, fi, and/or Plutus. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a virtual private network (VPN), and/or a wide area network (WAN), or the connection may be made to an external computer (for example, through the Internet using an Internet Service Provider). Any blockchain within this disclosure may be a cryptocurrency-based blockchain tied to any known cryptocurrency such as Ethereum, Ethereum Classic, Bitcoin, Litecoin, or any such currency based on a proof of work or proof of stake blockchain or a private blockchain based on frameworks such as Hyperledger Fabric and its variants, Multichain, R3 Corda, and/or Openblockchain.

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus or device provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instruction embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively or may include one or more stand-alone components. The hardware and software components of the computer system of the present disclosure may include and may be included within fixed and portable devices such as desktops, laptops, and/or servers. A module may be a component of a device, software, program, or system that implements some “functionality,” which can be embodied as software, hardware, firmware, and/or electronic circuitry.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

Furthermore, although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A peer to peer-based messaging and verification system comprising:
at least one processor;
a network;
a network communication device; and
a data store positioned in communication with the at least one processor, the network communication device, and the network, the data store containing instructions that, when executed by the at least one processor, cause the system to:
generate, thru the at least one processor, a solicitation for a request of credentialed information;
select, thru the network communication device, a vendor to provide the credentialed information;
complete, thru the at least one processor, a validation process by the vendor with access to the credentialed information; and
publish, onto the network, a record of the credentialed information by the vendor.

2. The system of claim 1 wherein the processor is further configured to secure a sum within an escrow account onto the network and release, onto the network, the sum from the escrow account in response to the publication of the record of the credentialed information.

3. The system of claim 1 wherein the processor is further configured to transmit a plurality of requirements for the credentialed information onto the network.

4. The system of claim 1 wherein the processor is further configured to add a plurality of negotiation elements to the solicitation, one of the negotiation elements including an element of work performed by the vendor and wherein the step of selecting the vendor is tied to the element of work.

5. The system of claim 1 wherein communications on the network occur thru an encrypted direct channel.

6. The system of claim 1 wherein the processor is further configured to confirm the identity of at least one peer thru the use of an encryption method.

7. A method of transmitting and verifying peer to peer-based messages comprising:
generating a solicitation for a request of credentialed information;
selecting a vendor to provide the credentialed information;
completing a validation process by the vendor with access to the credentialed information; and
publishing a record of the credentialed information by the vendor onto the network.

8. The method of claim 7 further including securing a sum within an escrow account on a network and releasing the sum from the escrow account in response to the publication of the record of the credentialed information.

9. The method of claim 7 wherein generating the solicitation for the request further includes adding a plurality of negotiation elements to the solicitation, one of the negotiation elements including an element of work performed by the vendor and wherein the step of selecting the vendor is tied to the element of work.

10. The method of claim 7 wherein selecting the vendor further consists of transmitting a plurality of requirements for the credentialed information.

11. The method of claim 7 wherein communications between the steps occur thru an encrypted direct channel.

12. The method of claim 7 wherein the identity of at least one peer is confirmed thru the use of an encryption method.

13. A non-transient computer-readable storage medium having instructions embodied thereon, the instructions being executable by one or more processors to perform a method of transmitting and verifying peer to peer-based messages comprising:
generating a solicitation for a request of credentialed information;
selecting a vendor to provide the credentialed information;
completing a validation process by the vendor with access to the credentialed information; and
publishing a record of the credentialed information by the vendor onto the network.

14. The computer-readable storage medium of claim 13 further including securing a sum within an escrow account on a network and releasing the sum from the escrow account in response to the publication of the record of the credentialed information.

15. The computer-readable storage medium of claim 13 wherein generating the solicitation for the request further includes adding a plurality of negotiation elements to the solicitation, one of the negotiation elements including an element of work performed by the vendor and wherein the step of selecting the vendor is tied to the element of work.

16. The computer-readable storage medium of claim 13 wherein selecting the vendor further consists of transmitting a plurality of requirements for the credentialed information.

17. The computer-readable storage medium of claim 13 wherein communications between the steps occur thru an encrypted direct channel.

18. The computer-readable storage medium of claim 13 wherein the identity of at least one peer is confirmed thru the use of an encryption method.
